(19) United States
(12) Patent Application Publication
(10) Pub. No.: US 2025/0271012 A1
(43) Pub. Date: Aug. 28, 2025

(54) INTERFACE FOR CONNECTING PARTIAL SHAFTS IN A FUNCTIONAL UNIT, FUNCTIONAL UNIT AND MACHINE TOOL

(71) Applicant: Hilti Aktiengesellschaft, Schaan (LI)

(72) Inventors: Benno LAIPPLE, Kaltental (DE); John Van TAACK-TRAKRANEN, Muenchen (DE)

(21) Appl. No.: 18/859,671

(22) PCT Filed: Apr. 12, 2023
(86) PCT No.: PCT/EP2023/059537

§ 371 Date: Oct. 24, 2024

(30) Foreign Application Priority Data
Apr. 26, 2022 (EP) 22169901.0

(51) Int. Cl. F16B 7/04

(52) U.S. Cl. CPC F16B 7/0413

(57) ABSTRACT

A machine tool having a micro-hammering function. This micro-hammering function can be achieved either by a particular configuration of the machine tool (“integrated” solution) or by providing an external module between the machine tool and its tool (“module solution”). In micro-hammering, impact movements which superimpose a pure rotary movement of the tool of the machine tool and can thus increase, for example, a drilling force of the machine tool, are generated. The external module or the machine tool has cam disks, one of which is fixed to the shaft and the other to the housing. The cam disks can be made or interact in such a way that an impact movement is generated by way of which the rotary movement of the tool of the machine tool can be superimposed. An external module for generating impact movements and to a system of machine tool and external module.

The present invention relates to an interface for connecting partial shafts in an external module or in a machine tool, the partial shafts being a constituent part of a functional unit for providing a micro-hammering or impact function.

### BACKGROUND OF THE INVENTION:

In the field of machine tools, drilling apparatuses, in particular core drilling apparatuses, are known, by way of which substantially cylindrical drill cores can be cut out of a substrate to be worked. As tool, such drilling apparatuses frequently have what is known as a core bit, which is driven to perform a rotary movement by a motor of the drilling apparatus. Such a drilling apparatus can have a mechanical transmission unit in order to operate the drilling apparatus in different gears and power ranges.

In order to increase the working power of such drilling apparatuses, drilling apparatuses which have an additional impact mechanism that is configured to generate impact movements and to impinge the pure rotary movement of the drilling apparatus with the latter have been proposed in the prior art. The result usually obtained is a superimposed movement made up of rotary and impact movements by way of which the subsoil can be worked.

### SUMMARY OF THE INVENTION

A disadvantage of these known drilling apparatuses with an integrated impact mechanism, however, is that they often have integrally configured shaft devices in which high loads on the bearings of the shaft device can arise. In certain circumstances, this can lead to critical loads acting on the bearing points and on the toothings of the spur gear stages. This may result in damage to the bearings and a high maintenance complexity of the machine tool.

It is an object of the present invention to overcome the above-described deficiencies and disadvantages of the prior art and to provide a technical solution for generating impact movements by way of which a rotary movement of a tool of a machine tool can be superimposed. The solution should be easy and convenient for the user to use and handle. In addition, mechanical impairments of the machine tool, the maintenance outlay for the machine tool and the transmission of vibrations to the user or a potentially used drill stand should be reduced.

Provided according to the invention is an interface for connecting partial shafts in a functional unit, the functional unit being configured for generating an impact movement S. The functional unit comprises a first cam disk and a second cam disk, the first cam disk being present so as to be connected to a shaft device and the second cam disk being present so as to be connected in a locationally fixed manner to a housing. The first cam disk and the second cam disk interact to generate the impact movement S, with the functional unit being configured to superimpose the rotary movement D of a tool of a machine tool with the impact movement S. The shaft device comprises a first partial shaft and a second partial shaft, the first partial shaft and the second partial shaft being able to be connected to one another by way of the interface. The interface for connecting partial shafts can preferably also be referred to as the shaft interface.

In an exemplary embodiment of the invention, an interface for connecting partial shafts in a functional unit is provided, it being possible for impact movements to be generated with the functional unit. The functional unit can interact with a machine tool having a tool, the tool of the machine tool being configured to carry out a rotary movement. The rotary movement of the tool of the machine tool can be superimposed with the impact movements. The functional unit can be a constituent part of an external module (“module solution”), the external module being able to be attached to a machine tool, or the functional unit can be present so as to be integrated in a machine tool (“integrated” solution).

In the context of the invention, it is preferred for the first cam disk of the functional unit to be a cam disk fixed to a shaft, i.e. to be connected to a shaft device of the functional unit, while the second cam disk of the external module is in the form of a cam disk fixed to a housing, in that the second cam disk is connected in a locationally fixed manner to the housing of the external module or the machine tool. In the context of the invention, it is preferred for the first cam disk to be fixedly connected to the shaft device in a rotational or tangential direction, while the second cam disk is fixedly connected to the housing in a rotational or tangential direction. Preferably, the shaft device and the first cam disk are configured to be movable in an axial direction, the shaft device and the first cam disk preferably being able to move back and forth together, i.e. conjointly, between detents, or in a certain range provided therefor. As a result of the movable design embodiment of the shaft device and the first cam disk, the axial stroke movements of the first cam disk and of the shaft device, which generate the impact movements, are preferably made possible.

An advantage of the invention lies in that with the functional unit, a pure rotary movement of the tool of the machine tool can be converted into a superimposed rotary and impact movement. When the functional unit is configured as an external module, depending on the application to be carried out, the user of the machine tool can decide whether or not he/she would like to use the external module to generate an impact movement. In other words, with the aid of the external module, the user can render a conventional machine tool which is configured to generate only a rotary movement capable of generating a superimposed rotary and impact movement. The external module can thus be used as a retrofitting option for conventional machine tools without an impact function, the machine tool advantageously being able to be rendered capable of generating a combined rotary and impact movement as a result of this retrofitting. As a result, a particularly flexible working and tool system can be provided. In particular, the user can use the external module for different machine tools so that, for example, an entire fleet of machine tools can be rendered capable of carrying out a superimposed rotary and impact movement. Moreover, the user no longer has to bring two different drilling apparatuses (with and without an impact function) to a construction site when he/she wishes to carry out drilling; rather, it is sufficient to bring along one drilling apparatus and the external module.

The superimposition of the impact movement generated by the functional unit on the rotary movement of the tool of the machine tool is, in the context of the invention, preferably also referred to as “imparting an impact movement to an existing rotary movement of a machine tool or of its tool”. The impact movements or impacts are preferably referred to as “micro-hammering”. With the invention, a micro-hammering function can thus be provided in particular. As a result of the use of the functional unit, the user of the machine tool is exposed to less stress from the impacts, since vibrations and impacts can be absorbed and thus significantly reduced by components of the external module. When the functional unit is configured as an external module, parts of the housing of the external module may comprise plastic or be made of plastic, so that these plastic components are configured to be elastic compared with the steel components and able to absorb impacts and vibrations. Furthermore, further damping means to further reduce impacts and vibrations for the user or the drill stand can be provided between the external module and the machine tool.

In addition, different lubricants can be used in the machine tool and in the functional unit. As a result, particularly good lubrication of the system and good protection of the components of the system against wear can be ensured overall.

The possibility of providing a micro-hammering function makes it possible in particular to be able to dispense with the use of rinsing or cooling water during operation of the machine tool. As a result, the amount of contamination at a construction site can be considerably reduced. Moreover, it is possible in this way to carry out for example core drilling operations at locations or construction site areas where there is no water supply, or in areas in which the use of rinsing or cooling water is not permitted. This can be the case for example in the region of absorbent construction materials such as plaster or cardboard, or in sensitive building types such as hospitals or the like, or in the vicinity of electrical installations such as server rooms or switchgear cabinets. Moreover, the work performed with the machine tool can be rendered safer since the combination of power and water can represent a safety risk on a construction site. As a result of the use of rinsing or cooling water being dispensed with, the invention can make possible “dry drilling” on a construction site, this representing an essential advantage of the invention.

As a result of the impact movements, which are preferably also referred to as “impacts” in the context of the present invention, working with the machine tool can be designed to be much more efficient. The machine tool may be in the form for example of a drilling apparatus or of a core drilling apparatus. The tool of the machine tool can then be, for example, a core bit by way of which cylindrical drill cores can be cut out of a substrate to be worked. Such drills may operate for example with a substantially static, i.e. constant, drilling force. Such a drilling force may lie for example in the region of 1000 newtons (N). The drills and their components are also configured for these drilling forces, meaning that a user can work with this substantially static drilling force without needing to fear that damage to or mechanical impairment of the machine tool or its components could occur.

Advantageously, by way of the invention, the drilling force can be increased considerably by means of the micro-impacts, so that work with a machine tool which has a functional unit for impact generation can be completed more quickly and more efficiently. This increase in the preferably substantially axially acting drilling force is preferably also referred to as “raising of the axial drilling force” in the context of the invention.

With the invention, an impact movement that can be superimposed with a rotary movement of a tool of a machine tool can be generated. The impact movement in this case preferably represents a substantially axial impact movement, which is preferably oriented along a shaft extending centrally in the system, or along a central apparatus axis of a machine tool. The impact movement is generated preferably by an alternating axial stroke between the two cam disks of the functional unit, wherein the alternating axial stroke is advantageously capable of transmitting a substantially axial drilling force to the tool of the machine tool.

It is preferred in the context of the invention that an input variable for the functional unit is substantially a pure rotary movement of the machine tool or its tool. This pure rotary movement can be superimposed by the micro-impacts, so that a mixed rotary and impact motion is generated by way of which a substrate can be worked. The rotary movement of the machine tool can be transmitted by the shaft device of the machine tool to the tool holder and/or the tool of the machine tool, whereby, preferably at the same time, a torque is also transmitted from the machine tool to the tool of the latter. The external module for generating impact movements, by way of which the pure rotary movement of the machine tool can be superimposed, can be present so as to be interposed between the machine tool and the tool of the latter. When the functional unit is configured as an integrated functional unit and as a constituent part of the machine tool, this transmission of rotary movement and/or torque can be effected particularly simply and with minimal losses.

A further advantage of the invention, when the functional unit is configured as an external module, is that, as a result of the provision of an external module, the location at which the impact movement is generated is separate from the remaining components, in particular the sensitive transmission components, of the machine tool. As a result of this physical separation of the impact generation and the machine tool, the components of the machine tool can be protected particularly well from mechanical loads that occur. Moreover, as a result of the physical separation, it is possible to use different lubricants in the external module and in the machine tool. For example, if a transmission, in particular a shift transmission, is used in the machine tool, the requirements placed on the lubricant to be used can differ considerably from the lubricant requirements set by the impact mechanism of the external module. On account of the physical separation, it is possible to use in the machine tool and in the external module lubricants that are matched optimally to the particular application without there being any risk of these lubricants undesirably mixing. As a result, it is advantageously possible for the output capacity and the lifetime of the machine tool, of the external module and of their respective components to be considerably increased or extended. This is also particularly advantageous for the reason that complex seals, as are customary in integrated solutions of impact mechanisms in machine tools, can be dispensed with. Moreover, it has been found that stress on the remaining transmission components of the machine tool by abrasion or abrasive particles can be substantially reduced.

A further advantage of the invention, when the functional unit is configured as an external module, lies in that, as a result of the physical separation and the provision of the external module, vibrations and impacts of the tool of the machine tool are transmitted to the user to a lesser extent. The user frequently holds the machine tool in his/her hands, whereby for this purpose the machine tool in a known manner may have one or two handles. In that the external module can be “interposed” between the tool and the machine tool, any transmission of vibrations that occur during operation of the tool of the machine tool is made substantially more difficult. As a result, the user's joints, in particular wrists, are substantially relieved of load or the user can alternatively work with the machine tool for longer without vibration or load limit values being reached. Thus, the invention also contributes toward protecting the health of the user of the machine tool to which an external module for impact generation is fastened.

It is preferred in the context of the invention that the cam disks each have at least one structural element, the structural elements generating an alternating axial stroke during a rotating relative movement of the first cam disk and the second cam disk. The structural elements can be configured, for example, as projecting ramps or as inward-protruding ramps. The cam disks preferably each have a surface on which the structural elements can be disposed. in the context of the invention, it is very particularly preferred that the cam disks in terms of the surfaces thereof are of substantially the same or identical design. In the context of the invention, this preferably means that the surfaces of the cam disks that lie opposite one another during operation of the machine tool have the same number of structural elements, the structural elements being configured substantially the same or similarly and being disposed at substantially corresponding locations and positions. The cam disks preferably have substantially the same or identical profiles. For example, 5 to 50 structural elements can be provided on a cam disk. In preferred embodiments of the invention, the cam disks can each have 10 to 30, and particularly preferably 15 to 20, structural elements. For example, 17 structural elements can be disposed on the cam disks, with tests having shown that particularly uniform and effective impacts can be generated when using cam disks with 17 structural elements. The structural elements can preferably be disposed uniformly on a circumference of the cam disks.

If the structural elements are configured in the form of a ramp, the structural elements can comprise an inclined plane which extends between a lowest point and a highest point of the structural element, while including an angle of inclination. A height difference between the lowest point and the highest point of the structural elements can be in a range from 0.1 to 3 mm, for example. The difference in height can preferably be in a range from 0.3 to 1 mm or particularly preferably approximately 0.5 mm. Differences in height of 0.35 or 0.65 mm have also proven to be particularly suitable for generating an axial stroke by way of which an effective impact movement can be generated.

The cam disks are mounted in the functional unit so that they have mutually facing surfaces, with the structural elements being located on the surfaces of the cam disks. The surfaces of the cam disks are pressed against one another during a rotating relative movement of the first and second cam disks, so that a “rattling” movement with a recurring axial stroke is generated.

The structural elements can preferably be in the form of inward-directed recesses or depressions which, for example, have the shape of an inward-directed ramp. However, in the context of the invention, it can also be preferable for the structural elements to be in the form of projecting elements which protrude from the base surfaces of the cam disks.

It is in the context of the invention that the structural elements of the one cam disk are traversed by the structural elements of the respective other cam disk during a relative rotary movement of the cam disks. The rotary movement is preferably implemented in that the first cam disk can co-rotate with the shaft device of the external module, while the second cam disk is stationary. The result is a rotary movement of the cam disks relative to one another. The axial stroke is preferably created in that the first cam disk, which is preferably configured to be movable in the axial direction, follows the course of the structural elements of the second cam disk in the axial direction. As a result, the first cam disk can be shifted or lifted in the axial direction. In particular, the first cam disk, or the shaft to which the latter is attached, is displaced in the direction of the machine tool by this axial stroke, so that the tool of the machine tool is lifted by a short distance. If the structural elements are ramp-shaped and include an inclined plane, the first cam disk follows the course of these inclined planes. The cam disk can preferably jump from the highest point back to the lowest point of the structural element, which is preferably configured in the form of a ramp, as a result of which the first cam disk jumps slightly in the axial direction. This small jump of the first cam disk is preferably referred to as “axial stroke” in the context of the invention. The jump of the first cam disk can be transferred to the tool of the machine tool by way of the shaft device. The impact movement is generated by the preferably abrupt recoiling of the first cam disk from the highest to the lowest point of the structural elements, which can then be transmitted as an impact movement of the tool of the machine tool to the substrate to be machined. The impact movement represents, in particular, an impact pulse by way of which the rotary movement of the tool of the machine tool can be superimposed. The impact pulse is generated in particular by the fact that the first cam disk after jumping hits or lands on the surface of the second cam disk.

It is preferred in the context of the invention that the above-described axial lifting movement of the first cam disk also causes the shaft of the functional unit to perform such an axial movement. This is advantageously achieved in that the shaft is present so as to be fixedly connected to the first cam disk. The first cam disk can therefore also be referred to as a “shaft-fixed cam disk”, while the second cam disk is present so as to be connected in a locationally fixed manner to the housing of the external module or the machine tool, i.e. in particular is configured so as to be “fixed to the housing”. In the context of the invention, it is very particularly preferred that the cam disks are pressed against or onto one another by the drilling force, and slide on one another in a rotating manner as a result of the rotary movement of the module shaft. The first cam disk, preferably configured so as to be movable, in the process preferably moves on the second cam disk, preferably configured in a locationally fixed manner, so that a relative movement between the cam disks comprises in particular a movement of the first cam disk on the second cam disk.

It is preferred in the context of the invention that the impact movement that can be generated by the functional unit has a higher frequency than the rotary movement of the machine tool and/or its tool. Preferably, the axial stroke has a higher frequency than the rotary movement of the machine tool or of the tool of the latter. This means in the context of the invention that the impact movement that is generated by the functional unit has a higher frequency than the existing rotary movement of the machine tool. In other words, the functional unit is specified to generate a number of impacts per unit of time, whereby this number of impacts is greater than a number of revolutions of the tool of the machine tool per same unit of time. This preferably means in the context of the invention that, per unit of time, more impact movements are generated than rotary movements of the tool of the machine tool take place. The impact movements may thus be generated preferably by a higher-frequency axial stroke.

It is preferred in the context of the invention that the functional unit has an extension of the shaft device. The shaft device of the external module, which is connected to the first “shaft-fixed” cam disk of the external module, may, in the context of the invention, preferably also be referred to as a “module shaft”, “transmission output shaft” or “shaft”, wherein the abovementioned terms are used synonymously in the context of the present invention.

The shaft device of the functional unit has two partial shafts. Preferably, one of the partial shafts of the functional unit is configured to be movable in the axial direction. It is preferred in the context of the invention that the first cam disk of the functional unit is disposed on the partial shaft configured to be movable in the axial direction, so that the first cam disk is also configured to be movable in the axial direction. In a particularly preferred embodiment of the invention, the first cam disk is in particular connected to the first partial shaft of the shaft device, so that the first cam disk can preferably co-rotate with the first partial shaft of the shaft device.

The second partial shaft can preferably represent an extension of the shaft device of the functional unit in the direction of the machine tool. In an alternative wording, the second partial shaft of the shaft device of the functional unit can also represent an extension of the shaft device of the machine tool into the functional unit. It is preferred in the context of the invention that the second partial shaft can also be referred to as an “input shaft of the functional unit”, in which case the second partial shaft can be screwed onto a shaft device or transmission output shaft of the machine tool. As a result, the second partial shaft preferably represents an extension of the shaft device or the transmission output shaft of the machine tool. The second partial shaft of the shaft device of the functional unit can thus preferably also be referred to as a transmission output shaft extension. The task of the latter is in particular to establish a connection between the functional unit and the machine tool, the connection between the functional unit and the machine tool being established in particular by a connection between the second partial shaft of the shaft device of the external module and the shaft device of the machine tool (“transmission output shaft”) being mediated. The first partial shaft of the functional unit can preferably be referred to as an “output shaft of the functional unit”.

It is preferred in the context of the invention that the first partial shaft can be introduced into a cavity of the second partial shaft. The first partial shaft can have an insertion end in a rear region, by way of which said first partial shaft can be introduced into the cavity of the second partial shaft. In other words, the output shaft of the functional unit can be inserted into a cavity of the input shaft of the functional unit, the output shaft and the input shaft conjointly preferably forming the shaft device of the functional unit. In the connected state, the first and second partial shafts can co-rotate, i.e. they are connected to one another in such a way that a rotary movement of one of the two shaft parts ensures that the other shaft part also rotates. It is preferred in the context of the invention that both partial shafts of the shaft device perform a common rotary movement. This common rotary movement and the associated torque transmission is preferably made possible by contours configured to be mutually corresponding and mating contours on the two partial shafts, or on the output shaft and on the input shaft, of the shaft device of the functional unit.

Of course, the partial shafts can also be configured in such a way that the second partial shaft has a cavity for receiving an insertion end of the first partial shaft. The first partial shaft can in this instance be inserted into the cavity of the second partial shaft in order to connect the partial shafts to one another so that they can co-rotate.

The mounting of the first partial shaft in the second partial shaft advantageously also enables axial mobility of the first partial shaft. It is preferred in the context of the invention that the first partial shaft can move axially within a range of approximately 2 mm, for example. In other words, an axial freedom of movement of the first shaft or the output shaft is in a range of approximately 2 mm, it being possible for the movement of the first partial shaft or the output shaft to be limited by detents within the functional unit. The axial freedom of movement of the first partial shaft of the shaft device of the functional unit is preferably somewhat larger than the axial stroke that is generated by the design embodiment and the relative movement of the cam disks.

It is preferred in the context of the invention that the shaft device of the functional unit, in particular a second partial shaft, is able to be connected to a shaft device of the machine tool. The shaft device of the machine tool which interacts with the shaft device of the functional unit may be in particular a transmission output shaft of the machine tool, or of the drilling apparatus. By connecting the input shaft of the shaft device of the functional unit to the shaft device of the machine tool, a connection between the functional unit and the machine tool can advantageously be established. The shaft device of the machine tool and the shaft device of the functional unit are preferably connected by way of a first interface. The first interface is specified in particular to connect the second partial shaft of the shaft device of the external module to the shaft device of the machine tool.

In the context of the invention, it is preferred that the housing of the functional unit is able to be connected to a housing of the machine tool. The functional unit preferably has a housing, wherein one of the cam disks of the functional unit is present so as to be fixedly connected to the housing. This cam disk is preferably referred to as a cam disk fixed to a housing or as a second cam disk. The housing of the functional unit can be connected axially to a housing of the machine tool. The machine tool may have, for example, a transmission housing or motor housing, which is preferably a constituent part of the housing of the machine tool. The connection between the housing of the functional unit and the housing of the machine tool may be brought about for example by way of a housing interface, which advantageously ensures an additional supporting function for the housing and which can make a contribution toward vibrations and impacts being transmitted to the machine tool and thus to the user to a lesser extent.

In the context of the invention, it is particularly preferred for the housing of the functional unit to be present so as to be connected axially to the transmission housing of the machine tool, or to be able to be connected to the transmission housing of the machine tool. For example, the housing of the functional unit can be connected to the housing of the machine tool by way of a mounting, wherein this mounting is preferably specified to interact with an extension of the shaft device of the functional unit. In the context of the present invention, it is preferred for the axial or drilling forces that arise to be generated by the operation of the machine tool and to be exaggerated by the additional impact movement, the latter being able to be generated with the aid of the functional unit. Such a functional unit can be of a particularly simple construction.

In the context of the invention, it is particularly preferred that when the functional unit which is configured as an external module is used, both the module input shaft, i.e. the second partial shaft, of the shaft device is present so as to be connected to the transmission output shaft of the machine tool, and the housing of the functional unit is also connected axially to the transmission housing of the machine tool. Both the connection of the shaft devices and the connection of the housings of the external module and of the machine tool can be brought about by way of a respective interface, which, in the context of the invention, are referred to preferably as first and second interface. The second interface may preferably also be referred to as a “housing interface”. Advantageously, as a result of this design embodiment of the connection of the external module and machine tool, a transmission of the drilling forces to the handles of the machine tool can be reduced. As a result, the user, or his/her wrists, is/are exposed to considerably less stress and it is possible to work for longer with the proposed system of external module and machine tool. If the machine tool is a stand-mounted machine tool, which is fastened to a drill stand during operation, a transmission of the drilling forces to the drill stand can be reduced by the invention. As a result of the reduced transmission of drilling forces to the drill stand, it is advantageously possible to prevent the mechanical stability of the attachment of the machine tool from being reduced, for example by vibrations or the like. Furthermore, as a result of the proposed connection between external module and machine tool, particularly sensitive components of the machine tool, such as bearings or roller bearings, are protected particularly effectively. As a result, the lifetime of the machine tool or its maintenance intervals can advantageously be extended.

When the functional unit is configured as an external module, the machine tool and the external module are preferably present so as to be connected to one another by way of a first interface and a second interface, the first interface being specified to connect the shaft device of the external module to a shaft device of the machine tool and the second interface being specified to connect the housing of the external module to a housing of the machine tool. Preferably, the first interface may be present in a contact region of the shaft devices of the external module and of the machine tool, while the second interface is present in a contact region of the housings of the machine tool and of the external module. In the context of the invention, it is very particularly preferred that the first interface is specified to connect the second partial shaft, or the module input shaft of the shaft device of the external module, to the shaft device of the machine tool, while the second interface is specified to connect the housings of the external module and of the machine tool to one another. The provision of the two interfaces between the machine tool and the external module advantageously prevents a force flux from taking place by way of sensitive components of the machine tool, for example the bearings of the latter. In addition, improved support between the external module and the machine tool is achieved.

By the provision of the two interfaces, the force flux can advantageously be guided from the transmission of the external module to the housing, in particular a transmission housing, of the machine tool, such that the sensitive components of the machine tool are protected particularly well from impairment. Furthermore, as a result of the provision of the two interfaces, an additional possibility for supporting the external module on the machine tool can be provided.

It is preferred in the context of the invention that a bearing of the housing of the functional unit on the shaft device is configured as a floating bearing. The housing can preferably be mounted on the second partial shaft of the shaft device by way of a floating bearing. It is preferred in the context of the invention that an axial redundancy can be prevented by a floating mounting of the housing on the shaft device of the functional unit. In other words, a floating mounting on the input shaft of the functional unit can be provided in order to particularly effectively prevent axial redundancy and transmission of exaggerated axial drilling forces to sensitive components of the machine tool. In this way, the machine tool can be protected against mechanical loads due to overuse.

The shaft device of the functional unit has a first partial shaft and a second partial shaft, the first partial shaft and the second partial shaft being able to be connected to one another by way of the interface according to the invention. Preferably, the first partial shaft or the second partial shaft can be configured to be locationally fixed in the axial direction, while the respective other partial shaft is configured to be movable in the axial direction. The respective other partial shaft, which is not configured to be locationally fixed, can move on the other hand, in particular in the axial direction, i.e. away from the other partial shaft or toward the other partial shaft. However, in the context of the invention, it may be preferable to provide detents which restrict the mobility of the partial shaft not configured to be locationally fixed, in order to prevent the unit from falling apart.

In the context of the invention, it is particularly preferred that the first cam disk is fixedly connected to the first partial shaft. The first partial shaft is preferably disposed in a front region of the functional unit, while the second partial shaft is disposed in a rear region of the functional unit. The first partial shaft can preferably be connected to a tool holder or a tool of the machine tool, so that the first partial shaft transmits the rotary movement of the machine tool, or a torque, to the tool of the latter. By way of the invention, the rotary movement of the tool can be superimposed with the impact movement generated by the cam disks, so that a superimposed impact and rotary movement is advantageously obtained for the tool of the machine tool. The first partial shaft can preferably represent the partial shaft, not configured to be locationally fixed, of the external module, which can move in particular in the axial direction, i.e. away from the other partial shaft or toward the other partial shaft. The locationally fixed partial shaft can then in particular be the second partial shaft.

The second partial shaft is preferably disposed in a rear region of the external module and can be connected to a shaft device of the machine tool. The shaft device of the machine tool preferably acts as a transmission output shaft and transmits the rotary movement of the motor of the machine tool to the shaft device of the functional unit. The shaft devices of the functional unit and the shaft device of the machine tool can be connected to one another, i.e. in particular screwed, with the aid of a thread. To this end, for example, the second partial shaft of the shaft devices of the functional unit can have an internal thread that interacts with a correspondingly configured external thread of the shaft device of the machine tool, in order to effect a threaded connection between the shaft devices.

It is preferred in the context of the invention that the interface according to the invention is specified to transmit different torques that occur during operation of the machine tool. The interface is furthermore configured to permit a preferably axial relative movement of the partial shafts of the module. This relative movement to be permitted between the partial shafts is preferably at least in an order of magnitude of the axial stroke, i.e. an amplitude of the impact movement. In other words, the partial shafts of the functional unit can move toward one another at least to the same extent as the cam disks do in order to generate the impact movement.

It is particularly preferred in the context of the invention that the first cam disk is present so as to be disposed (“shaft-fixed”) on the movable partial shaft. A substantial advantage of the interface, or of the design of the shaft device in two partial shafts, is that those components of the machine tool that are present so as to be disposed on the partial shaft that is configured to be locationally fixed cannot move in the axial direction relative to other transmission components of the machine tool. As a result, wear and tear on the components that are subjected to particularly high loads can be significantly reduced. In addition, due to the provision of the interface or due to the two-piece structure of the shaft device, it is no longer necessary for the toothing of the gear wheels to be used to be straight-toothed. Rather, helical gears can now also be used, which can advantageously increase the flexibility in the selection of the gears. In addition, improved running smoothness and increased strength can be achieved through the helical gearing.

In the context of the invention, it is preferred that the impact movement S by way of which the rotary movement D of the tool of the machine tool can be superimposed is able to be switched on and off by the cam disks of the functional unit being moved apart in an axial direction such that there is no longer any contact between the cam disks. The cam disks may preferably be moved apart by the first cam disk being moved away from the second cam disk or by the second cam disk being moved away from the first cam disk.

The cam disks may preferably be moved apart in that the first cam disk is moved away from the second cam disk. This preferably means, in the context of the invention, that the second cam disk fixed to a housing remains in a fixed position and is not moved, while the first cam disk, fixed to a shaft, is moved away from the second cam disk in an axial direction. The first cam disk may preferably be displaced conjointly with the shaft device of the machine tool. In the context of the invention, it may also be preferred, however, that the first cam disk is displaced without the shaft device of the machine tool. The shaft device preferably represents the transmission output shaft of the machine tool. In the context of the invention, it is preferred that the first cam disk, before it is moved away from the second cam disk, is present in a first position in which the micro-hammering function is provided. In this first position of the first cam disk, the first cam disk and the second cam disk are preferably in contact with one another and, as a result of the contact between the cam disks or as a result of their interaction, the impact movements by way of which the pure rotary movement of the machine tool or of its tool can be superimposed are generated. This state, in which the first cam disk is in the first position, in the context of the invention is preferably referred to as the “micro-hammering mode”.

In the context of the invention, it is preferred that the first cam disk, after it is moved away from the second cam disk, is present in a second position in which the system carries out a substantially pure rotary movement of the tool of the machine tool. In this second position of the first cam disk, the first cam disk and the second cam disk are preferably not in contact with one another but are separated from one another. As a result of the lack of contact between the cam disks, impacts for superimposing the pure rotary movement are no longer generated, and so the machine tool can be operated for example like a conventional core drilling apparatus without the micro-hammering function. This state, in which the first cam disk is in the second position, is referred to preferably as the “rotary movement mode” in the context of the invention.

In the context of the invention, it is preferable for the first cam disk to be moved away from the machine tool, meaning that a spacing between the machine tool and the first cam disk is increased.

In the context of the invention, it is preferred that the first cam disk is able to be fixed in a second position by way of a fastening element. Preferably, the cam disk can be axially fixed in the second position by the fastening element. The fastening element may preferably be specified to set or maintain a spacing between the first cam disk and other components of the system of external module and machine tool. For example, using the fastening element, a spacing between the first cam disk and a mounting on the main shaft can be set.

In the context of the invention, it is preferred that the cam disks are moved apart by moving the second cam disk away from the first cam disk. In the context of the invention this preferably means that the first cam disk fixed to a shaft remains in a fixed position and is not moved, while the second cam disk, fixed to a housing, is moved away from the first cam disk in the axial direction. In the context of the invention, it is preferred that the second cam disk, before it is moved away from the first cam disk, is in a first position in which the micro-hammering function is provided. In this first position of the first cam disk, the first cam disk and the second cam disk are preferably in contact with one another, so that the impact movements for superimposing the rotary movement of the tool of the machine tool can be generated (“micro-hammering mode”).

In the context of the invention, it is preferred for the second cam disk, after it is moved away from the first cam disk, to be in a second position in which the tool of the machine tool carries out a substantially pure rotary movement. In this second position of the first cam disk, the first cam disk and the second cam disk are preferably not in contact with one another but are separated from one another (“rotary movement mode”).

In the context of the invention, it is preferred for the second cam disk to be displaceable, or for it to be possible to displace it, relative to the housing by way of an actuating element. The second cam disk can preferably be displaced relative to the machine tool conjointly with the housing. In the context of the invention, this preferably means that the second cam disk, in this embodiment of the invention, can be displaced with respect to the shaft device.

In a second aspect, the invention relates to a functional unit, it being possible for the functional unit be present so as to be integrated in the machine tool. In an alternative design embodiment of the invention, the functional unit may be disposed as an external module between the tool and the machine tool. The terms, definitions and technical advantages introduced for the interface preferably apply in an analogous manner to the functional unit.

In a further aspect, the invention relates to a machine tool having a tool, the tool of the machine tool being configured to carry out a rotary movement. The terms, definitions and technical advantages introduced for the interface and the functional module preferably apply in an analogous manner to the machine tool. The machine tool is specified to generate an impact movement S, wherein a functional unit comprises a first cam disk and a second cam disk, the first cam disk being connected (“fixed to a shaft”) to a shaft device of the machine tool and the second cam disk being connected (“fixed to a housing”) in a locationally fixed manner to a housing of the machine tool; the first cam disk and the second cam disk interacting in order to generate the impact movement S; the machine tool being configured to superimpose the impact movement S on the rotary movement D of the tool of the machine tool. The machine tool preferably comprises a functional unit which is preferably a functional unit that is present so as to be integrated in the machine tool. In this embodiment of the invention, the shaft device, the cam disks or the partial shafts of the functional unit may for example be considered to be the shaft device, the cam disks or the partial shafts of the machine tool, the functional unit being an integral constituent part of the machine tool. In the context of the invention, the shaft device of the machine tool, to which the first cam disk can be connected, may preferably also be referred to as a transmission output shaft of the machine tool. In other words, the first cam disk can be mounted on the shaft device, or on the transmission output shaft, of the machine tool. In the context of the invention, it is in this case preferred for the entire shaft device advantageously to be able to move within the scope of the micro-hammering movement.

It is preferred in the context of the invention that the shaft device comprises a first partial shaft and a second partial shaft, the first partial shaft and the second partial shaft being able to be connected to one another by way of the interface according to the invention. The interface is specified to connect the first and the second partial shaft of the shaft device of the machine tool to one another. The interface is therefore preferably also referred to as a “shaft interface”. Preferably, the first partial shaft or the second partial shaft can be configured to be locationally fixed in the axial direction, while the respective other partial shaft is configured to be movable in the axial direction. In the context of the invention, this preferably means that a bearing assembly for the radial and/or axial positioning or fixing of the shaft device, or the output shaft, is provided within the machine tool. This bearing assembly can preferably be configured as a fixed/loose bearing or as a bearing assembly in an X or O arrangement. Because of the shaft interface, the partial shaft on the output side in particular is preferably axially movable. In the sense of this configuration, the output-proximal partial shaft is in particular the second partial shaft of the machine tool.

The respective other, non-stationary partial shaft of the machine tool can, in contrast, move, in particular in the axial direction, i.e. away from the other partial shaft or toward the other partial shaft. However, in the context of the invention, it may be preferable to provide detents that limit the mobility of the non-stationary partial shaft in order to prevent the shaft from falling apart. In addition, the machine tool has a gear wheel or a plurality of gear wheels, which are preferably also disposed on the stationary partial shaft of the machine tool. It is preferred in the context of the invention that the partial shafts of the shaft device are always specified to perform a rotary movement, while the axial mobility of the partial shafts of the shaft device can be partially restricted.

It is preferred in the context of the invention that the interface is specified to transmit different torques that occur during operation of the machine tool. The interface is also configured to permit a preferably axial relative movement of the partial shafts of the machine tool. This relative movement to be permitted between the partial shafts of the machine tool is preferably at least in the order of magnitude of the axial stroke, i.e. an amplitude of the impact movement. In other words, the partial shafts of the machine tool can move toward one another at least to the same extent as the cam disks of the machine tool do in order to generate the impact movement.

It is preferred in the context of the invention that the first cam disk is present so as to be disposed (“shaft-fixed”) on the movably configured partial shaft. During operation of the machine tool in particular, preferably only the movably configured part of the transmission output shaft of the machine tool moves, specifically preferably within the scope of the axial stroke of the impact movements by way of which the pure rotary movement of the machine tool can be superimposed.

A major advantage of the interface, or the preferably two-part design of the shaft device, of the machine tool is that those components of the machine tool that are disposed on the axially stationary partial shaft have no relative speed with respect to other transmission components of the machine tool. As a result, wear and tear on the components that are subjected to particularly high loads can be significantly reduced. Moreover, as a result of the proposed design of the machine tool with an interface or with a subdivision of the shaft device of the machine tool or the transmission output shaft of the machine tool into two partial shafts it is no longer necessary that the toothing of the gears used must be straight-toothed. Rather, helical gears can now also be used, as a result of which the flexibility in the selection of the gears can advantageously be increased. As a result, in particular the smooth running and the strength can be improved.

### BRIEF DESCRIPTION OF THE DRAWINGS

Further advantages are derived from the following description of the figures. The figures, the description and the claims contain numerous features in combination. A person skilled in the art will expediently also consider the features individually and combine them to form useful further combinations.

Identical and functionally equivalent components are denoted by the same reference signs in the figures, In the drawings:

FIG. 1 shows a schematic view of a preferred design embodiment of the system having a functional unit configured as an external module and a machine tool;

FIG. 2 shows a schematic view of a preferred design embodiment of the contact region between the external module and the machine tool;

FIG. 3 shows a lateral view (top) and a view from above (bottom) of a preferred design embodiment of a cam disk and the surface thereof;

FIG. 4 shows graphic explanations pertaining to the potential design embodiment of a surface of a cam disk and of the structural elements; and

FIG. 5 shows a schematic lateral view of a preferred design embodiment of an integrated solution having a shaft interface.

### DETAILED DESCRIPTION

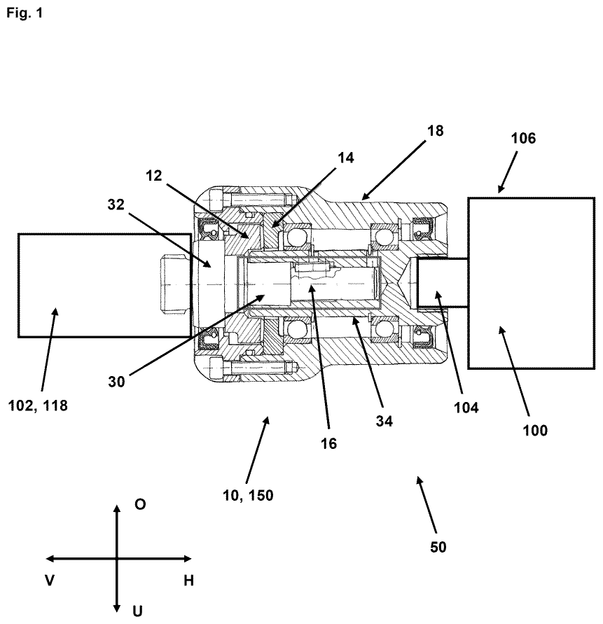

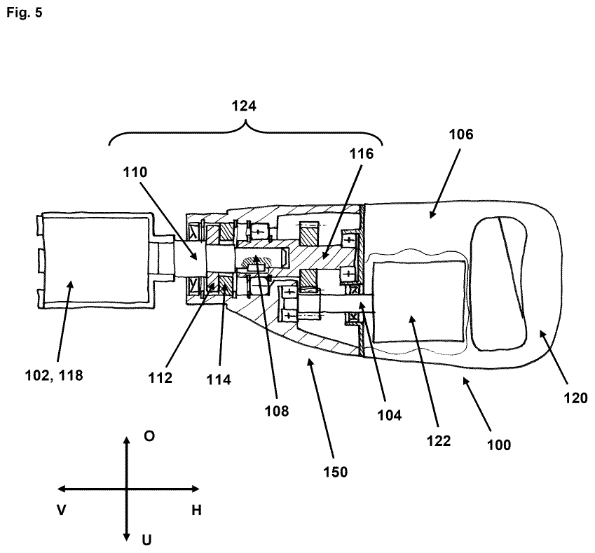

FIG. 1 shows a schematic view of a preferred design embodiment of a machine tool 100 which is connected to a functional unit 150 configured as an external module 10. Illustrated in the central region of FIG. 1 is the external module 10 which may be present so as to be disposed between the machine tool 100 and the tool 102 of the machine tool 100. The tool 102 of the machine tool 100 may be connected to the machine tool 100 by way of a tool holder 118. In the exemplary embodiment illustrated in FIG. 1, the external module 10 is disposed in particular between the tool holder 118 and the machine tool 100. The machine tool 100 can preferably be a drilling apparatus or a core drilling apparatus; the tool 102 of the machine tool 100 may be in the form for example of a core bit. The machine tool 100 has a motor (122, see FIG. 5), whereby the tool 102 of the machine tool 100 can be driven by way of shaft devices 104, 124 of the machine tool 100. In particular, the motor 122 of the machine tool 100 generates a rotary movement D, which can be transmitted to the tool 102 of the machine tool 100. The shaft device 104 of the machine tool 100 may preferably also be referred to as a transmission output shaft 104.

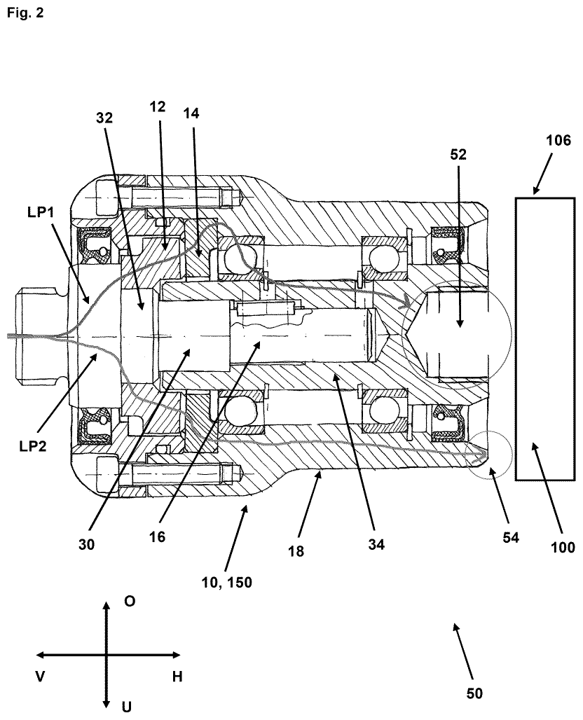

The impact movement S can advantageously be generated by a functional unit 150, it being possible for the functional unit 150 to be configured as an external module 10 (see FIGS. 1 and 2) or to be present so as to be integrated in the machine tool 100 (FIG. 5). The impact movements S which can be superimposed on the pure rotary movement D of the machine tool 100 are preferably also referred to as “micro-hammering”. In other words, a micro-hammering function for a machine tool 100 can be made available with the functional unit 150. The technical solution represented in FIGS. 1 and 2 relates to the generation of the impact movements S by an external module 10, while FIG. 5 shows a so-called integrated solution in which the impact movements S are generated within the machine tool 100 per se. The components of the functional unit 150 can then preferably also be considered to be components of the machine tool 100.

The external module 10 which is represented in FIGS. 1 and 2 can be “interposed” like an adapter between the tool 102 and the machine tool 100. The external module 10 has a first cam disk 12 and a second cam disk 14, the first cam disk 12 being fixed to a shaft, i.e. being connected to a shaft device 16 of the external module 10. The second cam disk 14 is preferably fixed to a housing. This preferably means, in the context of the invention, that the second cam disk 14 is connected to a housing 18 of the external module 10. Thus, the first cam disk 12 is capable of rotating, specifically conjointly with the shaft device 16 of the external module 10, while the second cam disk 14 is not specified for rotation. During operation of the machine tool 100, the first cam disk 12 is configured to be axially movable, so as to generate the axial stroke or the impact movement S. During operation of the machine tool 100, the second cam disk 14 is configured not to be movable in an axial direction. Preferably, the first cam disk 12 is capable of moving away from the second cam disk 14, so as to generate the axial stroke or the impact movement S. This preferably means, in the context of the invention, that the first cam disk 12 of the external module 10 can move in the spatial directions “toward the front” and “toward the rear”.

The spatial directions are illustrated using a direction cross. The spatial direction “toward the front” is indicated in this case by the letter “V”, while the spatial direction “toward the rear” is indicated by the letter “H”, the spatial direction “upward” by the letter “O” and the spatial direction “downward” by the letter “U”. The tool 102 of the machine tool 100 is accordingly disposed in a front region of the machine tool 10, while the machine tool 100 is depicted behind the external module 10 in FIG. 1. When the first cam disk 12 of the external module 10 moves, the shaft device 16 of the external module 10 preferably co-rotates, since the first cam disk 12 is fixedly connected to the shaft device 16 of the external module 10. In the context of the invention, it is preferred for the second cam disk 14 and the housing 18 of the external module 10 not to be able to move relative to the machine tool 100 during operation.

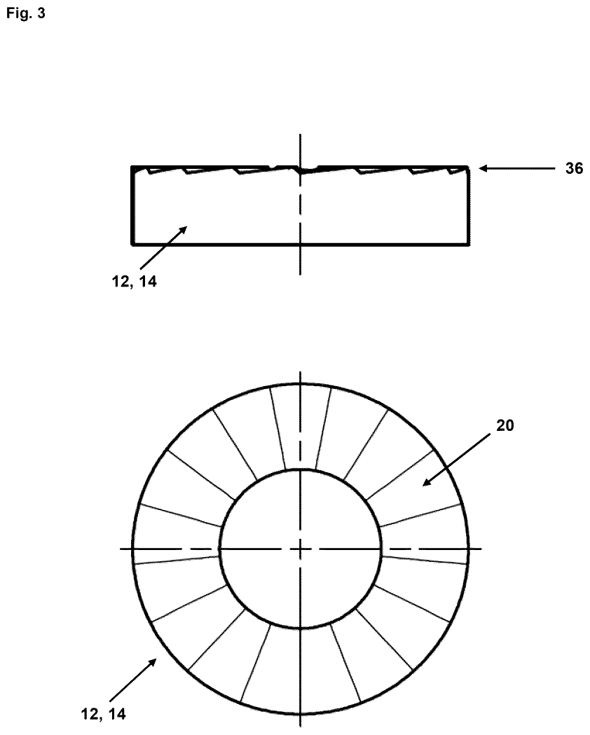

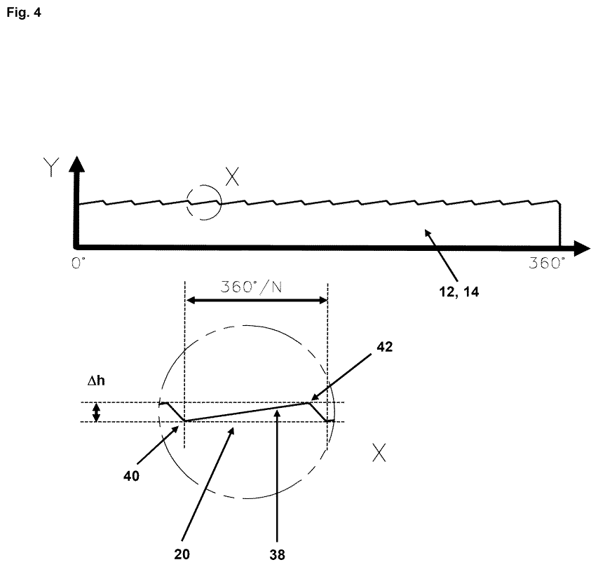

The two cam disks 12, 14 each have at least one structural element 20 (see FIGS. 3 and 4), the structural elements 20 being specified to generate the impact movements S when the cam disks 12, 14 move relative to one another during operation of the machine tool 100. As a result of the provision of the structural elements 20 on the two cam disks 12, 14, high surface pressures are advantageously avoided. The structural elements 20 may be configured ramp-like, for example, whereby a movement of one cam disk, for example the first cam disk 12, follows the height profile of the structural elements 20 of the other cam disk-for example the second cam disk 14—when the cam disks 12, 14 perform a rotating relative movement. In the context of the invention, it is preferred in particular for the first cam disk 12 to rotate while the second cam disk 14 is stationary. The standstill of the second cam disk 14 and the movement of the first cam disk 12 at a first rotating speed advantageously result in a relative movement of the cam disks 12, 14. Because of the drill contact pressure force by way of which the machine tool 100 is pressed onto the substrate to be worked, the cam disks 12, 14 are pressed together or on one another axially during their relative movement. In this way, the cam disks 12, 14 are predominantly present so as to be in close contact with one another and slide up and down according to the geometry or properties of the surfaces 36 of the cam disks 12, 14, so that the impact impulse or the impact movement is generated.

At the end of the ramp or of the structural element 20, the first cam disk 12 drops back onto the subsequent ramp of the cam disk 14, as a result of which an impact movement S is generated. In particular, an axial stroke is generated by the dropping action of a first cam disk 12. The axial stroke can preferably correspond to a distance, whereby the distance can correspond to the height of a ramp, i.e. a structural element 20, for example. If a plurality of structural elements 20 are provided on the cam disks 12, 14, this may result in an alternating axial stroke. This preferably means, in the context of the invention, that rapidly successive impact movements S are generated, which then form the micro-hammering function for the machine tool 100.

The external module 10 represented in FIGS. 1 and 2 may comprise an interface 30, wherein the interface 30 is specified to connect a first partial shaft 32 and a second partial shaft 34 of the shaft device 16 of the external module 10 to one another. In the exemplary embodiment of the invention illustrated in FIG. 1, the first cam disk 12, fixed to the shaft, is connected in particular to the first partial shaft 32 of the shaft device 16 of the external module 10. The interface 30 may preferably also be referred to as a “shaft interface”. One of the two partial shafts 32, 34, i.e. the first partial shaft 32 or the second partial shaft 34, may be fixed in position in the axial direction, while the respectively other partial shaft (34 or 32) is configured to be movable in the axial direction. In other words, one of the partial shafts 32, 34 can be displaced in a forward-rearward direction, while the other partial shaft 34, 32 is stationary.

In the case of the integrated solution represented in FIG. 5, the machine tool 100 can have an interface 108 for connecting the partial shafts 110, 116 of the shaft device 124 of the machine tool 100, the interface 108 being specified to connect a first partial shaft 110 and a second partial shaft 116 of the shaft device 124 of the machine tool 100 to one another. In such an integrated solution, too, the first partial shaft 110 or the second partial shaft 34 may be fixed in position in the axial direction, while the respectively other partial shaft 116, 110 is configured to be movable in the axial direction. In an integrated solution, the machine tool 100 may comprise two cam disks 112, 114, wherein the first cam disk 112 is connected to the shaft device 124 of the machine tool 100 and the second cam disk 114 is connected to the housing 106 of the machine tool 100. Preferably, the first cam disk 112 can be connected to the first partial shaft 110 of the shaft device 124 of the machine tool 100. In the context of the invention, it is preferred for the first cam disk 112 to be present so as to be disposed on the axially movable partial shaft (110 or 116), the first partial shaft 110 of the shaft device 124 of the machine tool 100 preferably being configured to be movable.

As represented in FIGS. 1 and 2, the second partial shaft 34 of the shaft device 16 of the external module 10 can represent an extension of the shaft device 16. The housing 18 of the external module 10 may be mounted on this second partial shaft 34 of the shaft device 16, the mounting 24 in particular being configured in the form of a floating bearing. The second partial shaft 34 of the shaft device 16 of the external module 10 is, in the context of the invention, preferably also referred to as a “transmission output extension” since, in a different perspective, it also represents an extension of the shaft device 104 of the machine tool 100 into the external module 10. The second partial shaft 34 can be connected to the shaft device 104 of the machine tool 100 in order for the rotary movement D of the machine tool 100 to be able to be transmitted to the tool 102 of the machine tool 100 by way of the shaft devices 16, 104.

The impact movement S by way of which the rotary movement D of the tool 102 of the machine tool 100 can be superimposed can advantageously be switched on and off by the cam disks 12, 14 being moved apart in an axial direction such that there is no longer any contact between the cam disks 12, 14. This pulling apart of the cam disks 12, 14 may take place for example in that the first cam disk 12 is moved away from the second cam disk 14. The first cam disk 12 may be in a first position before it is moved away and in a second position after it has been moved away, wherein the first cam disk 12 is able to be fixed in a second position by way of a fastening element 26. In the context of the invention, it is preferred for the cam disks 12, 14 to be moved apart by the actuation of a movement transmitting thread. A fastening element 26 may then be provided in order to fix the thread in the desired position.

The cam disks 12, 14 may, however, also be moved apart in that the second cam disk 14 is moved away from the first cam disk 12. In this case, the second cam disk 14 can be displaced relative to the housing 18 of the external module 10 by an actuating element 28. On account of the connection between the second cam disk 14 and the housing 18 of the external module 10, the second cam disk 14 can be displaced relative to the machine tool 100, in particular conjointly with the housing 18 of the external module 10.

FIG. 2 shows a schematic view of a preferred design embodiment of the contact region between the external module 10 and the machine tool 100. The external module 10 on the rear side thereof may be connected to the machine tool 100, while the external module 10 on the front side thereof may be connected to the tool holder 118 or to the tool 102 of the machine tool. In order to connect the external module 10 to the machine tool 100, at least two interfaces 52, 54 may be provided, wherein the first interface 52 is specified to connect the shaft device 16 of the external module 10 to a shaft device 104 of the machine tool 100, while the second interface 54 is specified to connect the housing 18 of the external module 10 to a housing 106 of the machine tool 100. In the context of the invention, it is preferred for it to be possible in particular for the second partial shaft 34 of the shaft device 16 of the external module 10 (“module input shaft”) to be connected to the shaft device 104 of the machine tool 100 by way of the first interface 52.

In particular, the housing 18 of the external module 10 can be connected to the housing 106 of the machine tool 100. Furthermore, the second partial shaft 34 of the shaft device 16 of the external module 10 can be connected to the shaft device 104 of the machine tool 100. Contact points or contact regions between the external module 10 and the machine tool 100 thus exist in particular in the region of the housings 18, 106 of the external module 10 (“second interface 54”) and of the machine tool 100, and in the region of the shaft devices 16, 104 (“first interface 52”). The first interface 52 and the second interface 54 between the machine tool 100 and the external module 10 are depicted in particular in FIG. 2.

Different load paths LP1, LP2 which demonstrate the potential profiles of the force flux within the external module 10 are illustrated in FIG. 2. The upper, first load path LP1 is a potential load path that the force flux can take within the external module 10. The lower, second load path LP2 is the preferred load path, by which the force flux is introduced into the housing 106 of the machine tool 100. As a result, sensitive components within the machine tool 100 can be protected better than in the case of the load path LP1 in which the force can be introduced into the shaft devices 16, 104 of the external module 10 and of the machine tool 100, respectively. As a result, it is possible for bearings or roller bearings, for example, to be damaged.

FIG. 3 shows a lateral view and view from above of a preferred embodiment of a cam disk 12, 14 and its surface 36. Structural elements 20 can be provided on the surface 36 of the cam disks 12, 14, a number of the structural elements 20 being identified by the reference sign “N”. For example, six complete structural elements 20 are illustrated in the lateral view of a cam disk 12, 14 shown in the upper region of FIG. 3. The structural elements 20 in the exemplary embodiment of the invention illustrated in FIG. 3 are configured as ramps which comprise an inclined plane 38 (see FIG. 4) and are identified by a height difference Δh between the lowest point 40 and the highest point 42 of the ramp 20 (see FIG. 4). For example, the cam disk 12, 14 shown in FIG. 3 has seventeen structural elements 20, so that N=17. Illustrated in the lower region of FIG. 3 is a view from above of a surface 36 of the cam disk 12, 14.

FIG. 4 shows graphic explanations pertaining to the potential design of a surface 36 of a cam disk 12, 14 and of the structural elements 20. It is preferred in the context of the invention that the structural elements 20 are present so as be disposed uniformly on the circumference of the cam disk 12, 14. In the case of such uniformly disposed structural elements 20, the length of the inclined plane 38 is preferably the same or similar. However, in the context of the invention, it may also be preferable that the structural elements 20 are not disposed uniformly on the circumference of the cam disk 12, 14. The inclined planes 38 of the structural elements 20 can then have different lengths. It is preferred in the context of the invention that the heights Δh of the structural elements 20 are each the same or similar. The height difference Δh can be in a range of 0.5 mm, for example.

The upper region of FIG. 4 shows by way of example a development of a profile of a cam disk 12, 14 with seventeen structural elements 20, the structural elements 20 being distributed over the full circle) (360°) of the cam disk 12, 14. Illustrated by way of example in the lower region of FIG. 4 is a lateral view of a potential design embodiment of a structural element 20. The structural element 20 has an inclined plane 38 which extends between a lowest point 40 and a highest point 42 of the structural element 20. The structural element 20 shown at the bottom of FIG. 4 is, for example, configured in the shape of a ramp, whereby a difference in height Δh between the lowest point 40 and the highest point 42 of the structural element 20 can be in a range of 0.5 mm, for example.

FIG. 5 shows a lateral view of a so-called “integrated solution” having a shaft interface 108. The functional unit 150 is an integral constituent part of the machine tool 100 here. FIG. 5 shows in particular a machine tool 100 in which the micro-hammering function is provided or generated within the machine tool 100 per se. For this purpose, the machine tool 100 includes a first cam disk 112 and a second cam disk 114, which are configured and finished in accordance with the statements for the cam disks 12, 14 of the external module 10. The cam disks 112, 114 of the machine tool 100 are also specified to interact in the same way in order to generate impact movements S and/or impact pulses, so that the machine tool 100 shown in FIG. 5 is inherently able to provide a micro-hammering function. The machine tool 100 depicted in FIG. 5 has a housing 106 and a shaft device 104. The shaft device 104 corresponds preferably to a rotor shaft of the motor 122 of the machine tool 100. Moreover, the machine tool 100 may have a handle 120. The machine tool 100 may have a transmission, such that the shaft device 104 of the machine tool 100 does not necessarily have to be present so as to be connected directly to the motor 122 of the machine tool 100. For example, gears or additional shaft devices (inter) may be provided between the rotor shaft 104 and the motor 122 of the machine tool 100 in order to adapt a speed of the motor 122, for example. Preferably, the transmission of the machine tool 100 may be specified to reduce a high speed of the motor 122 such that a speed suitable for drilling can be achieved for the tool 102 of the machine tool 100. The shaft devices 104, 124 of the machine tool 100 may be present so as to be disposed in a mutually offset manner in an upward/downward direction and/or a forward/rearward direction, whereby the shaft devices 104, 124 of the machine tool 100 are oriented preferably substantially parallel to one another.

In the machine tool 100 illustrated in FIG. 5, the shaft device 104 is configured to interact with a further shaft device 124, which, in the case of the provision of the micro-hammering function by an external module 10, corresponds to the shaft device 16 of the external module 10. This further shaft device 124 may preferably comprise a first partial shaft 110 and a second partial shaft 116, wherein the first partial shaft 110, in terms of its function, corresponds to the first partial shaft 32 of the external module 10 and the second partial shaft, in terms of its function, corresponds to the second partial shaft 34 of the external module 10. In the integrated solution in which the micro-hammering function is provided by the machine tool 100 per se, an interface 108 for connecting the two partial shafts 110 and 116 is also provided. The items that are identified by a cross in FIG. 5 may preferably be bearings or roller bearings, which enable an axial movement of the first partial shaft 110 and of the first cam disk 112 fastened thereto, such that an impact movement S can be generated, or a micro-hammering function can be provided, by the machine tool 100.

In the integrated solution in which the impact movement S is generated within the machine tool 100 per se, in that the functional unit 150 is an integral constituent part of the machine tool 100, the impact movement S can also be switched on and off. For example, this can be achieved in that the cam disks 112, 114 are moved apart in an axial direction such that there is no longer any contact between the cam disks 112, 114. This pulling apart of the cam disks 112, 114 may take place for example in that the first cam disk 112 is moved away from the second cam disk 114. The first cam disk 112 may be in a first position before it is moved away and in a second position after it has been moved away. In the context of the invention, it is preferred for the cam disks 112, 114 to be moved apart by the actuation of a movement transmitting thread. The cam disks 112, 114 may, however, also be moved apart in that the second cam disk 114 is moved away from the first cam disk 112.

### LIST OF REFERENCE SIGNS

10 External module
12 First cam disk
14 Second cam disk
16 Shaft device of the external module
18 Housing of the external module
20 Structural elements
24 Mounting of the housing of the external module
26 Fastening element
28 Actuating element
30 Interface
32 First partial shaft, module output shaft
34 Second partial shaft, module input shaft
36 Surface of a cam disk
38 Inclined plane of a structural element
40 Lowest point of a structural element
42 Highest point of a structural element
50 System comprising a machine tool and an external module
52 First interface
54 Second interface
100 Machine tool
102 Tool of the machine tool
104 Shaft device of the machine tool
106 Housing of the machine tool
108 Interface for connecting the partial shafts
110 First partial shaft
112 First cam disk of the machine tool
114 Second cam disk of the machine tool
116 Second partial shaft
118 Tool holder of the machine tool
120 Handle of the machine tool
122 Motor of the machine tool
124 Further shaft device
150 Functional unit
S Impact movement
D Rotary movement
Δh Height difference of the structural elements
N Number of structural elements
V Front, front side, spatial direction “toward the front”
H Rear, rear side, spatial direction “toward the rear”
U Bottom, lower side, spatial direction “downward”
O Top, upper side, spatial direction “upward”
LP1 Load path 1
LP2 Load path 2

What is claimed is:

1-12. (canceled)

13. An interface for connecting partial shafts in a functional unit, the functional unit being configured for generating an impact movement, the functional unit including a first cam disk and a second cam disk, the first cam disk being connected to a shaft device and the second cam disk being connected in a stationary manner to a housing; the first cam disk and the second cam disk interacting to generate the impact movement; the functional unit being configured to superimpose a rotary movement of a tool of a machine tool with the impact movement; the shaft device including a first partial shaft and a second partial shaft; the interface comprising: a connection for connecting the first partial shaft and the second partial shaft.

14. The interface as recited in claim 13 wherein the first cam disk and the second cam disk each have at least one structural element, so that an alternating axial stroke is generated in a relative movement between the first cam disk and the second cam disk.

15. The interface as recited in claim 13 wherein the first partial shaft or the second partial shaft is configured to be stationary in the axial direction, while the respective other partial shaft is configured to be movable in the axial direction.

16. The interface as recited in claim 13 wherein the first cam disk is present so as to be disposed on the movably configured partial shaft.

17. The interface as recited in claim 13 wherein the impact movement has a higher frequency than the rotary movement of the machine tool or of the tool.

18. The interface as recited in claim 13 wherein the impact movement with which the rotary movement of the tool of the machine tool is superimposable is able to be switched on and off in that the first and second cam disks are moved apart in an axial direction to so that there is no contact between the first and second cam disks.

19. The interface as recited in claim 13 wherein the first and second cam are moved apart by the first cam disk being moved away from the second cam disk.

20. The interface as recited in claim 13 wherein the first and second cam disks are moved apart by the second cam disk being moved away from the first cam disk.

21. A functional unit comprising the interface as recited in claim 13 wherein the functional unit is present so as to be integrated in the machine tool.

22. A functional unit comprising the interface as recited in claim 13 wherein the functional unit is disposable as an external module between the too and the machine tool.

23. A machine tool comprising: a tool configured to carry out a rotary movement, the machine tool specified to generate an impact movement; a shaft device; a housing and a functional unit, the functional unit including a first cam disk and a second cam disk, the first cam disk being connected to the shaft device and the second cam disk being connected in a locationally fixed manner to the housing; the first cam disk and the second cam disk interacting in order to generate the impact movement; the machine tool being configured to superimpose the impact movementon the rotary movement of the tool.

24. The machine tool as recited in claim 23 wherein the shaft device includes a first partial shaft and a second partial shaft, the first partial shaft and the second partial shaft being able to be connected to one another by way of an interface.
